(19) United States
(12) Patent Application Publication
(10) Pub. No.: US 2005/0234985 A1
(43) Pub. Date: Oct. 20, 2005

(54) System, method and computer program product for extracting metadata faster than real-time

(75) Inventors: Joseph Gordon, Jessup, MD (US); Michael Veronis, Bethesda, MD (US); Scott Hopkins, Baltimore, MD (US)

Correspondence Address: VENABLE LLP, P.O. BOX 34385, WASHINGTON, DC, 20045-9998, US

(73) Assignee: Nexjenn Media, Inc., Jessup, MD (US)

(21) Appl. No.: 10/821,199

(22) Filed: Apr. 9, 2004

(51) Int. Cl. G06F 7/00

(52) U.S. Cl. 707/104.1

(57) ABSTRACT

A system, method and computer program product for extracting metadata from one or more content files in faster than real-time, where the content files may be received from more than one source.

### BACKGROUND OF THE INVENTION

Some exemplary embodiments of the present invention are generally related to meta-data extraction, and more particularly, to the extraction of meta-data about content.

Metadata or data about data, describe the content, quality, condition, and other characteristics of data. For example, metadata can include information known about an image or other type of data content. Metadata can be used as an index to describe or to provide access to image data. Metadata can also include information about intellectual content of the image, digital representation of data, and security or rights management information about the data.

One form of data is generally referred to as content. Content can include, e.g., audio and video data. Analog content can be digitized resulting in digital content. Digitized content is a computer representation of some sampled stream of information such as, e.g., an analog audio signal, or analog video signal. Digital video content can include a stream of digitized frames of bitmapped images.

Metadata can be extracted from content. Conventionally, metadata was extracted from audio and video content in real-time. Generally, full motion video can include, e.g., approximately 30 frames of bitmapped data per second, i.e., a large amount of information assuming relatively high resolution images, over a very short time period.

When extracting metadata from video in real-time, conventionally, frames are dropped since metadata extraction processing equipment cannot keep up with the incoming stream of video content data. Similarly for audio data, not all audio sampled is processed if the metadata extraction processing equipment cannot keep up with an incoming stream of audio data. The number of frames of video for which metadata is available is thus limited by the processing power of the extraction equipment and the extraction equipment's capacity to process data at a sufficient rate to keep up with the data capture equipment. Unfortunately this conventional approach of extracting metadata is less than optimal for applications where metadata is required to be captured for all units of content potentially available.

### BRIEF DESCRIPTION OF THE DRAWINGS

The invention shall be described with reference to the accompanying figures, wherein:

FIG. 1 illustrates an overview diagram of a metadata extraction content processing system, according to an exemplary embodiment of the present invention;

FIG. 2 illustrates a block diagram of the metadata extraction content processing system, according to an exemplary embodiment of the present invention;

FIG. 3 illustrates a diagram of a file upload mechanism, according to an exemplary embodiment of the present invention;

FIG. 4 illustrates a diagram of a directory watcher feature, according to an exemplary embodiment of the present invention;

FIG. 5 illustrates a flowchart of an edit configuration feature, according to an exemplary embodiment of the present invention;

FIG. 6 illustrates a flowchart of a prepare jobs feature, according to an exemplary embodiment of the present invention;

FIG. 7 illustrates a diagram of a task manager, according to an exemplary embodiment of the present invention;

FIG. 8 illustrates a diagram of a histogram service, according to an exemplary embodiment of the present invention;

FIG. 9 illustrates a diagram of a histogram feature, according to an exemplary embodiment of the present invention;

FIG. 10 illustrates a diagram of an audio service, according to an exemplary embodiment of the present invention;

FIG. 11 illustrates a diagram of a real producer, according to an exemplary embodiment of the present invention;

FIG. 12 illustrates a diagram of a Synchronized Multimedia Integration Language (SMIL) service, according to an exemplary embodiment of the present invention;

FIG. 13 illustrates a diagram of a Mixed Excitation Linear Predictive (MELP) service, according to an exemplary embodiment of the present invention;

FIG. 14 illustrates a diagram of a delete service, according to an exemplary embodiment of the present invention;

FIG. 15 illustrates a diagram of a database subsystem, according to an exemplary embodiment of the present invention;

FIG. 16 illustrates a diagram of a universal database, according to an exemplary embodiment of the present invention;

FIG. 17 illustrates a diagram of a snapshot report, according to an exemplary embodiment of the present invention; and

FIG. 18 illustrates a block diagram of an exemplary computer environment useful for implementing the invention.

The invention is now described with reference to the accompanying drawings. In the drawings, like reference numbers generally indicate identical, functionally similar, and/or structurally similar elements. The drawing in which an element first appears is generally indicated by the left-most digit(s) in the corresponding reference number.

### DETAILED DESCRIPTION OF EXEMPLARY EMBODIMENTS

While the present invention is described in terms of the examples below, this is for convenience only and is not intended to limit its application. In fact, after reading the following description, it will be apparent to one of ordinary skill in the art how to implement the following invention in alternative exemplary embodiments (e.g., using alternatives to Java™ such as, e.g., but not limited to, C, C+, or Visual Basic™).

Furthermore, it will be apparent to one skilled in the relevant art how to implement the following invention, where appropriate, in alternative servers and databases. For example, the present invention may be applied, alone or in combination, with various system architectures and their inherent features.

In this detailed description of various exemplary embodiments, numerous specific details are set forth. However, it is understood that alternative embodiments of the invention may be practiced without these specific details. In other instances, well-known circuits, structures, and/or techniques have not been shown in detail in order not to obscure an understanding of this description.

References to “one embodiment,” “an embodiment,” “example embodiment,” “various embodiments,” “exemplary embodiments,” etc., indicate that the embodiment(s) of the invention so described may include a particular feature, structure, or characteristic, but not every embodiment necessarily includes the particular feature, structure, or characteristic. Further, repeated use of the phrases “in one embodiment,” or “in an exemplary embodiment,” do not necessarily refer to the same embodiment, although the phrases may.

Exemplary embodiments of the present invention may include systems or apparatuses for performing the operations herein. A system or apparatus may be specially constructed for the desired purposes, or it may comprise a general purpose device selectively activated or reconfigured by a program stored in the device.

Exemplary embodiments of the invention may be implemented in one or a combination of hardware, firmware, and software. Exemplary embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

In addition, the following table, TABLE 1 lists some of the many terms which may be used in the description of aspects of the present invention and its exemplary embodiments.

TABLE 1
ABBREVIATIONS AND ACRONYMS

| | |
|---|---|
| AGP | Accelerated Graphics Port |
| AVI | Advanced Video Interleave |
| CDR | Critical Design Review |
| CD-ROM | Compact Disk - Read Only Media |
| CD-RW | Compact Disk - Read Writeable |
| CMM | Capability Maturity Model |
| COTS | Commercial-of-the-Shelf |
| CPU | Central Processing Unit |
| CSC | Computer Software Component |
| CSCI | Computer Software Configuration Item |
| CSU | Computer Software Unit |
| DDRAM | Dual Data RAM |
| DIMM | Dual In-line Memory Module |
| DRAM | Dynamic RAM |
| DVD | Digital Video Disk |
| EJB | Enterprise Java Beans |
| FDD | Floppy Disk Drive |
| FQT | Formal Qualification Testing |
| GB | Giga-Byte |
| GUI | Graphic User Interface |
| HDD | Hard Disk Drive |
| J2EE | Java 2 Enterprise Edition |
| J2SE | Java 2 Standard Edition |
| JMF | Java Media Framework |
| JNI | Java Native Interface |
| LEDS | Leading Edge Design & Systems |
| MB | Mega-Byte |
| MPEG | Motion Picture Expert Group |
| OE | Operating Environment |
| PCI | Peripheral Component Interconnect |
| PDR | Preliminary Design Review |
| PS/2 | Personal System/2 |
| RAM | Random Access Memory |
| ROM | Read-Only Memory |
| SCM | Software Configuration Management |
| SDK | Software Development Kit |
| SDP | Software Development Plan |
| SLOC | Source Lines of Code |
| SMIL | Synchronized Multimedia Integration Language |
| SQA | Software Quality Assurance |
| SRSR | Software Requirements Specification Review |
| STP | Software Test Plan |
| STR | Software Test Report |
| UI | User Interface |
| URN | Uniform Resource Name/Number |
| USB | Universal Serial Bus |
| XML | Extensible Mark-up Language |

The present invention may provide a system, method and computer program product for extracting metadata from content in faster than real-time. A preferred exemplary embodiment of the invention is discussed in detail below.

An exemplary embodiment of the present invention is directed to a system, method, and computer program product for extracting metadata from content at faster than real-time. In an exemplary embodiment, the method may generate key frames from various types of, e.g., but not limited to, video stream files, viewing the key frames, viewing the status of the job, and isolating portions of the video stream file such as, e.g., an audio portion and linking it to the key frames.

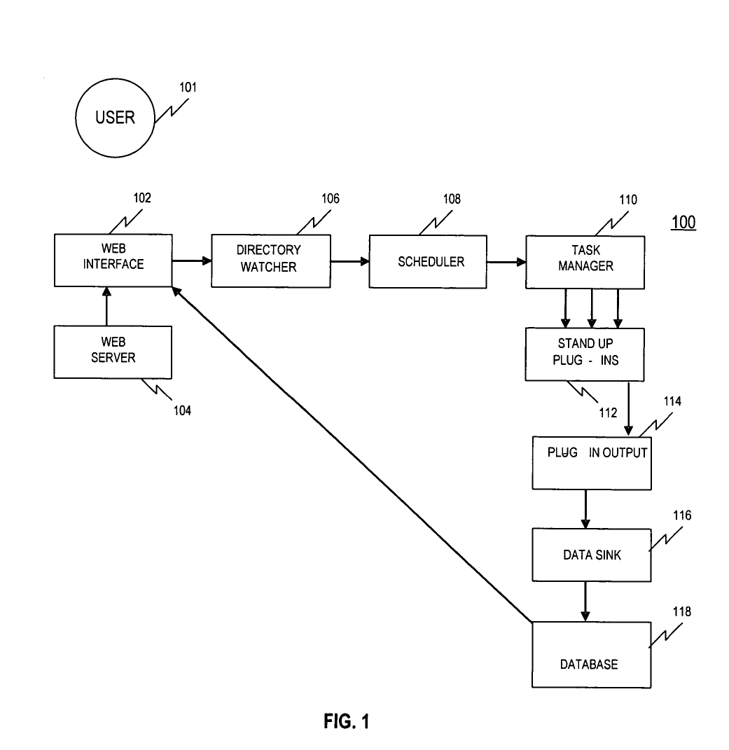

Referring to FIG. 1, a block diagram illustrating an exemplary metadata extraction content processing system 100, according to an exemplary embodiment of the invention, showing the network connectivity among the various components is shown. For example, system 100 may include in an exemplary embodiment, the MEDIAMER™ metadata-extraction content-processing system available from LEADING EDGE DESIGN & SYSTEMS® of Severn, Md., U.S.A. It should be understood that the particular metadata extraction content processing system 100 in FIG. 1 is shown for illustrative purposes only and does not limit the invention. As will be apparent to one skilled in the relevant art(s) based at least on the teachings described herein, all of components “inside” (not shown) of the metadata extraction content processing system 100 are connected directly, or coupled via a digital or analog network, or other components.

The metadata extraction content processing system 100 shows an exemplary embodiment of a general design of the system of the present invention. In one exemplary embodiment, a web server 104 can provide services to an end-user 101 via web interface 102 through which the core functionality of the exemplary metadata extraction content processing system 100 may be made available. In one exemplary embodiment, the web server 104 may be a TOMCAT™ server, which can be an exemplary servlet container that may be used in the official reference implementation for the JAVA™ Servlet and JAVASERVER™ Pages (JSP) technologies that are provided through a community process by Sun Microsystems® of Santa Clara, Calif., USA. In alternative embodiments, the web server may be implemented with Jetty, Resin and/or Orion, which, along with Tomcat, may be written in Java unlike Internet Information Services (IIS) available from MICROSOFT of Redmond, Wash., U.S.A. which may be written in something other than a NET language. The benefit is that customizations and extensions may be more straightforward in Java web server implementations. Non-java implementations, such as IIS, are just as readily applied to web server 104 and the processes of system 100.

As a job is uploaded into the metadata extraction content processing system 100 from the web interface 102 by the end-user 101, that job can be identified by the directory watcher 106 and can be scheduled for processing by the scheduler 108. In one exemplary embodiment, the task manager 110 then may take the job and distribute it to one or more plug-ins 112. Once the output 114 from the plug-ins is produced, a Data Sink 116 can produce a user specified file and an XML file sink can take XML data, which was produced by the plug-ins 112, and can make an insertion entry into a database 118. In one exemplary embodiment, a relational database may be employed. In exemplary embodiments of the present invention, several relational databases may be implemented in, e.g., Java, these include, e.g., but not limited to, Pointbase™, HSQL™, Instantdb™, Firstsql™ and Cloudbase™. These offer the advantage of allowing deployment of a database 118 where Java is deployed. Some of them even allow Java types to be used in the database. Cloudscape™ is a database product licensed by International Business Machines® (IBM®) of Armonk, N.Y., USA. Other trademarks are the property of their respective owners. In an exemplary embodiment, once the results of the operations are served by database 118, the end-user can view the results via the JSP reports provided through the web interface 102.

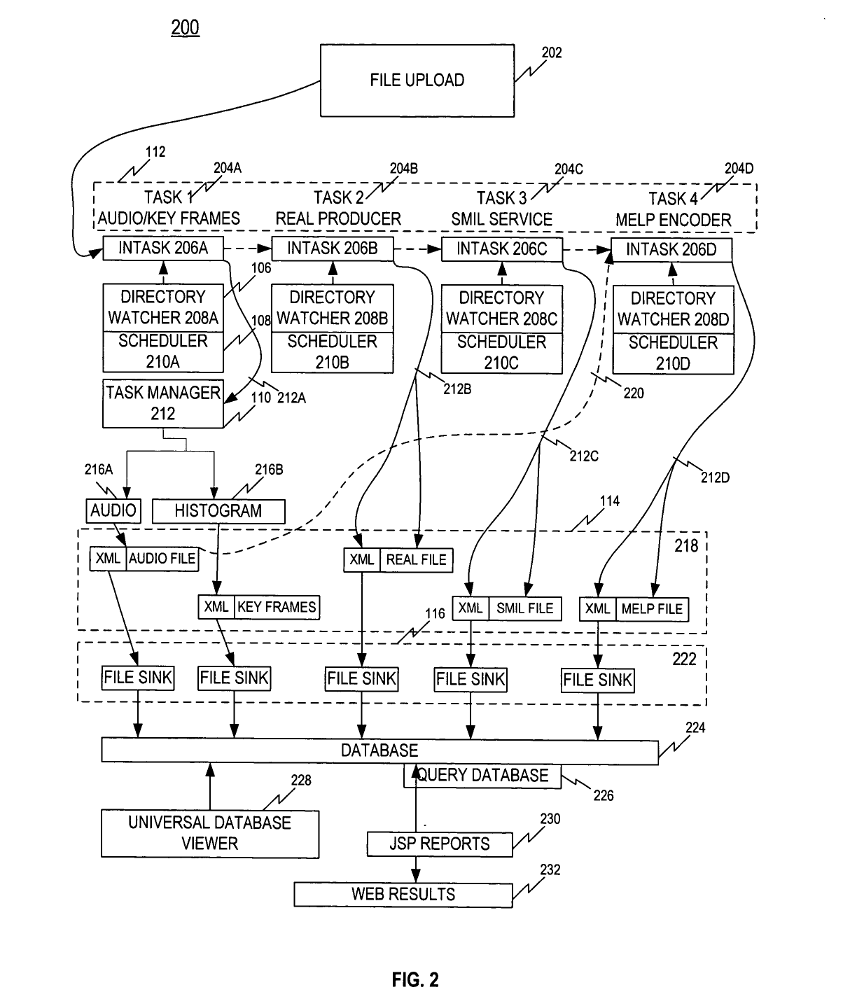

With regard to FIG. 2, the metadata extraction content processing system 200 begins with a file upload 202. In one exemplary embodiment, the file can be uploaded from the web interface 102. Processing of the file may begin at Task 1 (204a) at processing point intask 206a, which can be responsible for producing audio and key frames.

After Task 1 has been completed or while Task 1 is executing, a copy of the file can be made and provided to Task 2 (204b) at processing point intask 206b, which can be responsible for a Real Producer plugin. In some exemplary embodiments, similar copies may be provided to Task 3 (204c) at processing point intask 206c, which can be responsible for the Synchronized Multimedia Integration Language (SMIL) task; and also to Task 4 (204d) at processing point intask 206d, which can be responsible for the Mixed Excitation Linear Predictive (MELP) encoding. According to one exemplary embodiment of the present invention, each of the tasks then processes the copy of the file that they have received appropriately.

Task 1 (204a) may continue to take that file, which may be discovered by its Directory Watcher 208a, and split up the job between plug-ins, such as between the Audio Service 216a and the Histogram Service 216b. The Audio Service 216a may make plug-in outputs such as, e.g., but not limited to, an audio file and XML data to be sent through the xml file sink (part of element 222), which can then be inserted into the database 224, which can be an implementation of database 118. Meanwhile, the audio file can also be copied and sent to Task 4 (204d)(which can be responsible for the MELP encoding) by disposition to be processed further.

Task 2 (204b) can meanwhile be processing that file, which was discovered by its Directory Watcher 208b and Scheduler 210b. After processing, a real file and XML data (part of element 218) can be produced and the XML data can be inserted into the database 224, after passing through the file sink 222.

Task 3 (204c) can also be processing that file, which was discovered by its Directory Watcher 208c and Scheduler 210c. After processing, a SMIL file and XML data (part of element 218) can be produced and the XML data can be inserted into the database 224, after passing through the file sink 222.

Meanwhile, in an exemplary embodiment, after Task 4 (204d) receives its copy of the file, which can be discovered by its Directory Watcher 208d and Scheduler 210d, it continues to go through processing. A MELP file and XML data (part of element 218) can both be produced and the XML data can be inserted into the database 224, after passing through the file sink 222.

Thus, processing of separate plug-in tasks 1-4, 204A-D, may occur in parallel on given stored content stream in uploaded file 202. The streams may include digital video and audio tracks, in an exemplary embodiment. Tasks may be instantiated for execution on one or more systems having one or more processors. A file may be divided into multiple subfiles for further parallel processing. Advantageously, by processing a stored data file that has captured in the file all frames of content, extraction of metadata by multiple plugins may occur in parallel, and processing of each and every frame of the content (e.g., all audio and video tracks) may be performed since processing of the metadata need not be performed in realtime. Thus, no frames of content data are lost, and metadata may be captured for 100% of the available captured content. Conventionally, metadata extraction was processed, at its fastest, in realtime, to the extent that metadata processing could keep up to the realtime rate of data capture. Thus, conventionally, frames that could not be processed for metadata, would be lost, or so-called “dropped.” Using the present invention, since content to be processed for metadata is previously stored, e.g., in digital format, the content may be processed in parallel, e.g., using multiple instances of metadata processors or plug-ins. For example, the content may be divided and the subdivisions of content may be processed in parallel. Also, copies of the content may be made and different plug-ins can process the copies of the content in parallel. Thus, the present invention is not limited by the realtime length of running time of streaming content, but may instead only be limited by the amount of processing power available. For example, if one has one running hour of video stream, conventionally, if metadata processing equipment could at best keep up with the video stream, then metadata could be captured in one hour. However, using the present invention, the same one hour of video could be processed in less time, such as, e.g., in ¼ of the time, if 4 parallel instances were able to process metadata using a metadata processor that runs at a similar rate to a conventional processor. Thus, by storing the stream and performing post processing, instead of attempting to process metadata in realtime, much greater amounts of content can be processed for metadata in the same amount of time. Also, assuming all frames are captured in the stored version of the content, the present invention may ensure that metadata is extracted for each and every frame of video, especially important in various applications where this required such as, e.g., in security related applications where content might include, e.g., video surveillance imagery. Thus, instead of conventional processes that would at best process a given two hours of live video, completing extraction of metadata at the end of the two hour period, the present invention instead could extract the metadata from the video in much less time, than two hours say, e.g., in ten minutes, since, according to an exemplary embodiment of the present invention, metadata may be extracted from a stored content stream, by parallel processing and multi-tasking. Thus, the present invention can process very large amounts of content, extracting metadata, since the present invention does not attempt to process the metadata in realtime like conventional systems. The present invention can further ensure to extract metadata from each and every frame since it can process frames one by one, independently of realtime, and any system limitations, since the present invention again processes a stored content stream rather than a live content feed. Particularly in security based applications, such as, e.g., homeland security applications, such as, video monitoring of, e.g., persons entering a train station, or an airport, where enormous amounts of video can be produced, it will be apparent to those skilled in the art that the present invention provides substantial improvement over conventional methods by providing an efficient means of extracting metadata from the content, as well as guaranteed integrity by ensuring each and every frame is analyzed and corresponding metadata extracted.

According to exemplary embodiments of the present invention, various tools can be used to view the database. In one exemplary embodiment, the Universal Database Viewer of Artyom Rabzonov (http://www.tyomych-proj.narod.ru/readme.usage.htm, last visited on 20 Jan. 2004), may be used to view the database 224. In another exemplary embodiment, another database viewer may be used. The universal database viewer 228, like other tools, allows the viewing of each table of the database 224, along with its contents. These tools can also be used to present snapshot reports on the web-browser interface 102 by querying the database 118 and displaying the results as, e.g., JSP type reports 230.

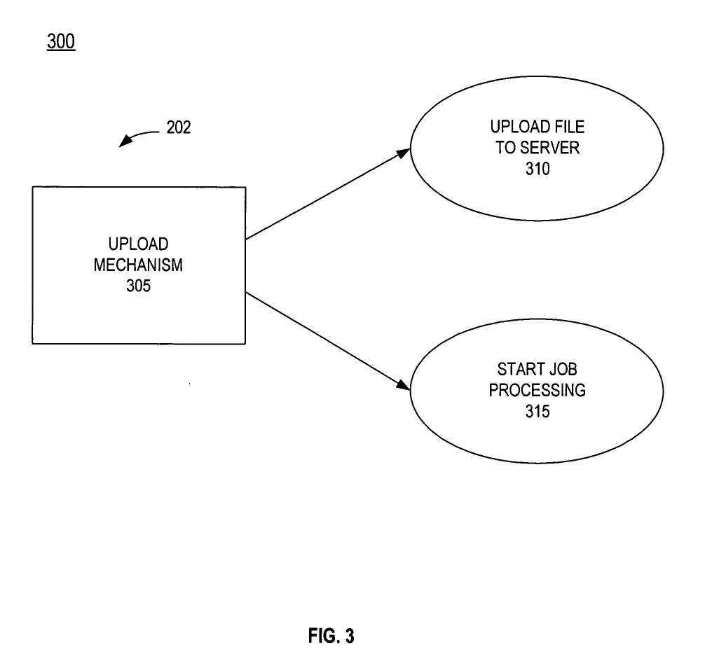

With regard to FIG. 3, the File Upload Mechanism 305 may provide a graphical user interface (GUI) by which a client can easily select a source file and then have it uploaded to the system 100, 200. It also may provide a mechanism by which any client (user) can select uploaded files (on the server) and begin the processing of the files. In one exemplary embodiment, the system 200 uses JSP and provides a GUI mechanism via a web-browser to the user. Upload File to Server 310 may take a user specified file and may upload it to the server. Start Job Processing 315 may take any user selected files from the server and begin processing it.

The File Upload Mechanism 305 may interact with the user 101, who may select which file he or she would like uploaded to the system 100 or 200 to begin processing. After a job is submitted, the Directory Watcher 106 and Scheduler 108, may watch for and schedule processing of any files designated or uploaded, as previously described herein.

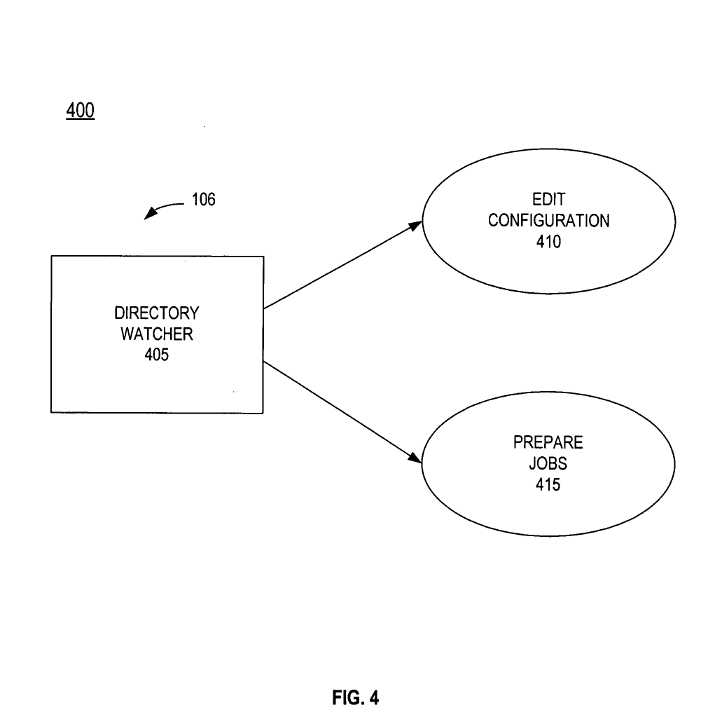

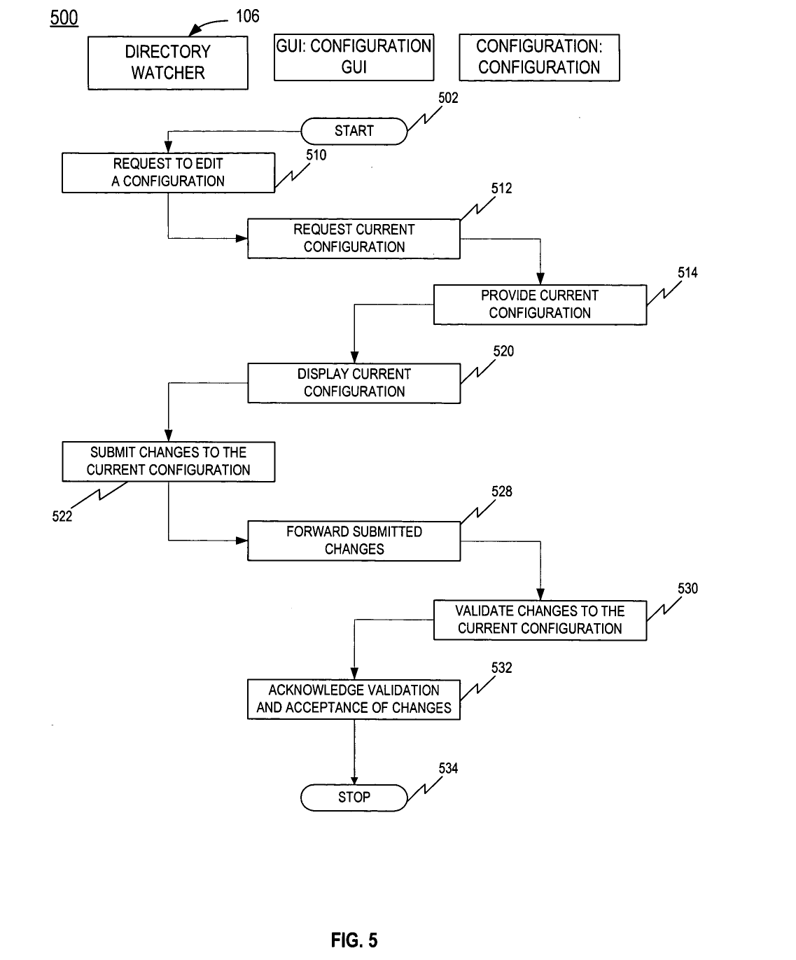

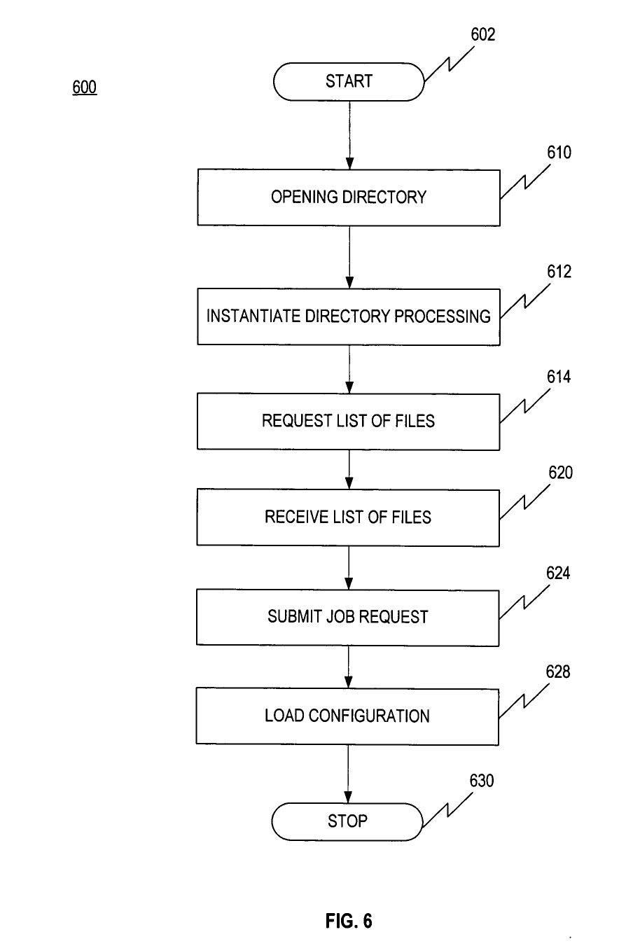

With regard to FIG. 4, the Directory Watcher 405 may provide a mechanism by which input source media content can be injected into the system environment 100, 200 via a systematic controlled approach. In one exemplary embodiment, the Directory Watcher 405 and Scheduler may take into account input source media types and may schedule them for processing at some point in time. This point in time may be immediately or when the next processing slot is available. In one exemplary embodiment, the Watcher 405 may run in the background on the system 100 or 200 and may not have a ‘GUI’ associated with it. In another exemplary embodiment of the present invention, the directory watcher 405 may be set up to “watch” more than one directory. Edit configuration 410, discussed in more detail in FIG. 5, graphically displays one exemplary embodiment of the present invention, in which an exemplary process is described in which the directory watcher 405 may edit configurations to the xml file. The directory watcher 405 may also prepare jobs, at block 415, discussed in more detail in FIG. 6, that may be determined via at least one of user choice, priority rating, schedule, or relevance to another job.

With regard to FIG. 5, exemplary process 500 is separated to promote the reader's understanding and not necessarily to indicate that there are three separate processes. The directory watcher of process 500, such as, e.g., but not limited to directory watcher 405 or 208a-d, may begin operations at block 502 and may proceed immediately to block 510, where it may request to edit a configuration. In one exemplary embodiment, the request may be prompted by a client. The process may proceed to block 512, where the GUI may request the current configuration and may provide the current configuration in block 514. In one exemplary embodiment, the GUI may display the current configuration, as shown in block 520. The process then may proceed to step 522, where changes to the current configuration may be submitted by the directory watcher. These changes may be forwarded to the GUI at block 528 for validation (block 530) and acknowledgement (block 532) of validation and acceptance of changes. The process may terminate at block 534. The process may be instantiated in one or more instances.

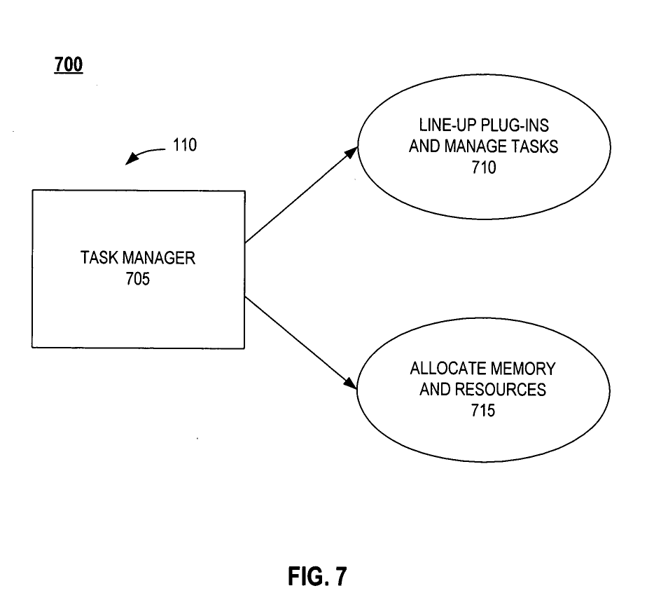

With regard to FIG. 6, the scheduler/directory watcher may interact with jobs that are to be processed by user determination. Once the scheduler finds ajob to be processed, the scheduler may schedule the job, according to a priority rating, and may prepare the job, where control can be passed to the task manager, as shown in FIG. 2, and further discussed below with regard to FIG. 7. The job processing illustrated in the exemplary embodiment of FIG. 6, may begin at block 602 and may immediately proceed to step 610, where the directory may be opened by the scheduler/directory watcher. The process may proceed to block 612, where directory processing may be instantiated by the directory watcher. The process may then proceed to block 614, where the watcher may request a list of files and may receive them in block 620. At block 624, the job request may be submitted and the configuration information may be loaded (at block 628). The process may then terminate at block 630. The process may be instantiated in one or more instances.

With regard to FIG. 7, the Task Manager Subsystem (TMS) 705 may provide a framework to perform the operations of each task. TMS 705 may be responsible for instantiating tools that may be used for the task to be completed. TMS 705 may manage each task and may have the ability to schedule different processing as necessary. Task manager 705 may have the ability to perform dynamic load balancing. Task manager 705 may also provide a definition of tools that may be used to complete the task. As such, the task manager 705 may line-up the plug-ins, and the manager 705 may manage the tasks, as indicated at block 710, which may include the task manager 705 looking for plug-ins and determining which task to complete.

In one exemplary embodiment of the present invention, the TMS 705 also may measure the performance of each task and can, in an exemplary embodiment, dynamically add or subtract resources. Resources may be varied to assure proper processing power such as, e.g., memory and other resources such as, e.g., processing power and storage, may be correctly allocated to the task, as indicated by block 715. As described elsewhere herein, according to the teachings provided herein, each task may happen to reside on multiple computing platforms and may not be necessarily limited to a single computer for performing all of the task's work.

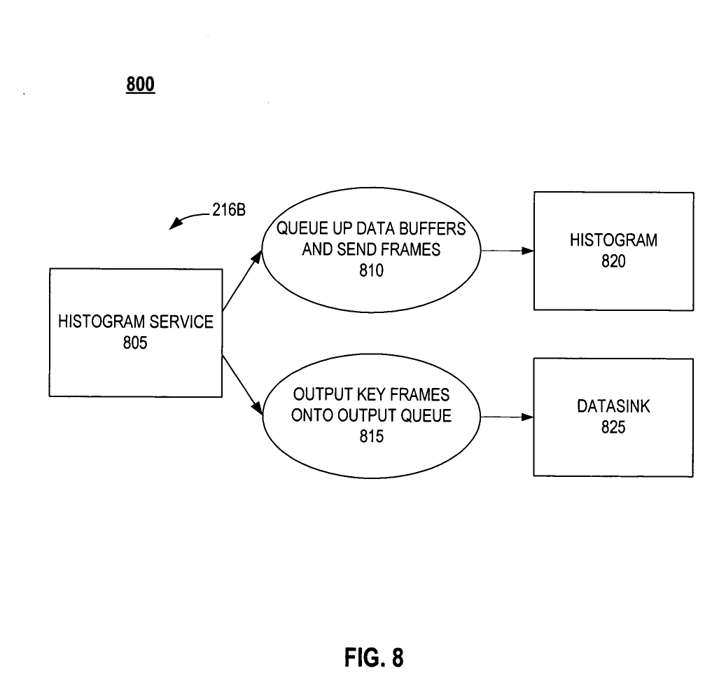

In one exemplary embodiment of the present invention, the allocation of memory and resources of block 715 may include, e.g., but not limited to, the task manager 705 that may be used to allocate memory and resources for different tracks, services, and sinks, such as, e.g., those illustrated in FIG. 2. The task manager 705 such as task manager 110, may then start each of them, putting data into a queue for the histogram service 216B or audio service 216A, also illustrated in FIG. 2, and further discussed below with respect to FIGS. 8-10.

In one exemplary embodiment of the present invention, with respect to interface design, the task manager 705 may take a job that has been prepared for processing by the scheduler/directory watcher and can begin by lining-up the plug-ins and determining which task to complete based on the scheduler/directory watcher. For example, once at task has been selected for processing and/or completion of processing, the task manager 705 may then interact with, e.g., the histogram service 216B or audio service 216A by pushing data into the queue for these services.

With regard to FIG. 8, histogram service 805 may conform to the service level plug-in interface requirements provided for herein and described in exemplary embodiments and examples below. According to exemplary embodiments of the present invention, the service level plug-in interface may provide management of the data buffers for the histogram service. The histogram service 805 such as, e.g., histogram service 216B, may queue-up data buffers as they become ready for processing from, e.g., the task manager, at block 810. Also at block 810, frames from the video may be sent to the histogram 820 where each may be evaluated.

At block 815, output key frames, which may be output onto the output queue, may include key frames, which the histogram 820 has specified, on an output buffer that can go to a data sink 825. In one exemplary embodiment, a YUV data sink may be used, where a file of key frames can then be produced. As one of ordinary skill in the art would recognize, based at least on the teachings provided herein, the image formats, such as YUV may be altered, as the present invention and its exemplary embodiments are not limited to any particular data or image format.

In one exemplary embodiment of the present invention, the histogram service 805 may interact with the task manager 705 by taking the buffers of data from the queue that the task manager prepared. The histogram service 805, 216B may then interact with the histogram 820, by passing frames of video, so that each can be evaluated. Once the histogram 820 has specified what the key frames are, the histogram service may then interact with the data sink 825, where a file of key frames may be produced.

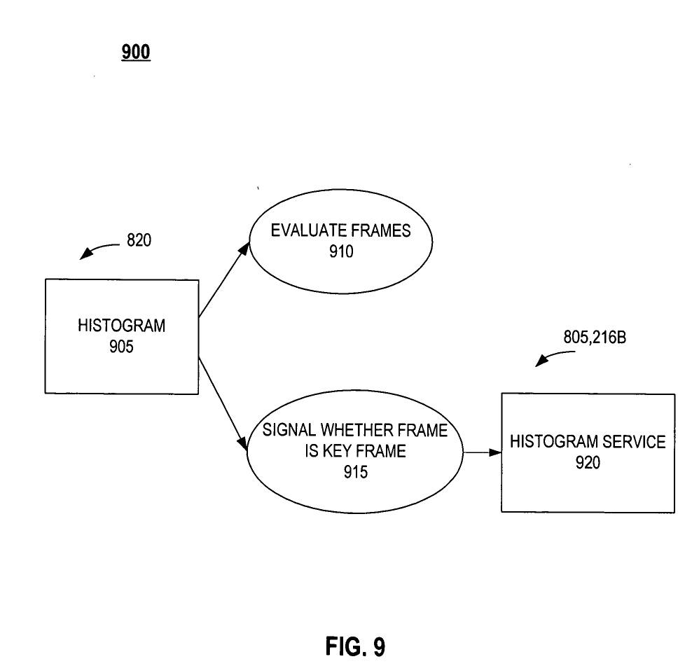

With regard to FIG. 9, as discussed above, the histogram's purpose may be to evaluate frames of a video based on a threshold or a specific number. For example, the histogram may evaluate, e.g., but not limited to, every frame, or every 10^{th} frame, which is illustrated at block 910. In one exemplary embodiment, for the evaluation on a threshold, an algorithm for the histogram 905 may include counting and running a tally of which pixel may be in each part of an image. This process may be repeated for another frame and another tally can be run. The difference in tallies from the two frames for each numbered-pixel can be then calculated and the total amount of the differences for each numbered-pixel can be then added together. If the total can be greater than the set threshold, the images may then be considered “different enough.”

For the evaluation on a specific number, the algorithm include, e.g., taking every “Nth” frame. At block 915, the histogram 905 may signal whether a frame is a key frame. In one exemplary embodiment, block 915 may include returning of a value of “true” or “false” to the histogram service 805. In one exemplary embodiment of the present invention, for the evaluation on a threshold, if an image can be considered “different enough” from the preceding image, a value of “true” can be returned; otherwise a value of “false” can be returned.

In an alternative exemplary embodiment, for the evaluation on a specific number, a value of “true” can be returned on every “Nth” frame; otherwise a value of “false” can be returned. The histogram 905 may interact with the histogram service 920 by taking the frames that were given and evaluating each one. After evaluation, the histogram 905 may then interact with the histogram service 920 again, by signaling (true or false) as to whether a frame was a “key frame” based on a specific threshold or specific frame number.

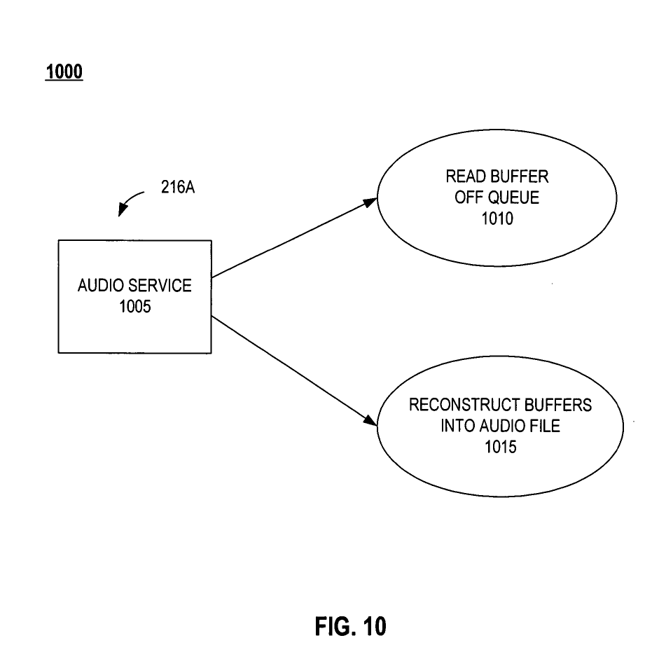

With regard to FIG. 10, the audio service 1005 such as, e.g., audio service 216A, may be responsible for taking buffers of raw audio, in any format, such as, e.g., but not limited to mulaw, ulaw, linear, etc., which may include several milliseconds of audio per buffer, and reconstructing them into one audio file in a format of one or more accepted mime types, such as, e.g., but not limited to, the content types in service by the Internet Corporation for Assigned Names and Numbers (IANA)(http://www.iana.org), which may include, e.g., application, audio, image, message, model, multipart, text, and video. With respect to video and audio formats, the audio service may read buffers of audio off of a queue at block 1010, which may include a class, which may sit on top of another track that can be set as its input, and may handle reading buffers of data off of the queue. In one exemplary embodiment, this class may be termed the source stream.

In another exemplary embodiment, the audio service 1005 may reconstruct buffers as illustrated in 1015 into an audio file based on an audio buffer data source class, which can be a wrapper that allows the components of the present invention, such as the components of FIG. 2, to be connected to a Java Media Framework (JMF) processor, which may collect the buffers and then may send the contents of the buffers to a JMF data sink where a file can be produced by reconstructing the buffers.

In one exemplary embodiment of the present invention, the audio service 1005 may interact with the task manager 705 by taking the buffers of data from the queue that the task manager prepared. After the audio service 1005 collects the buffers, it then may interact with the JMF data sink, where an audio file can be produced.

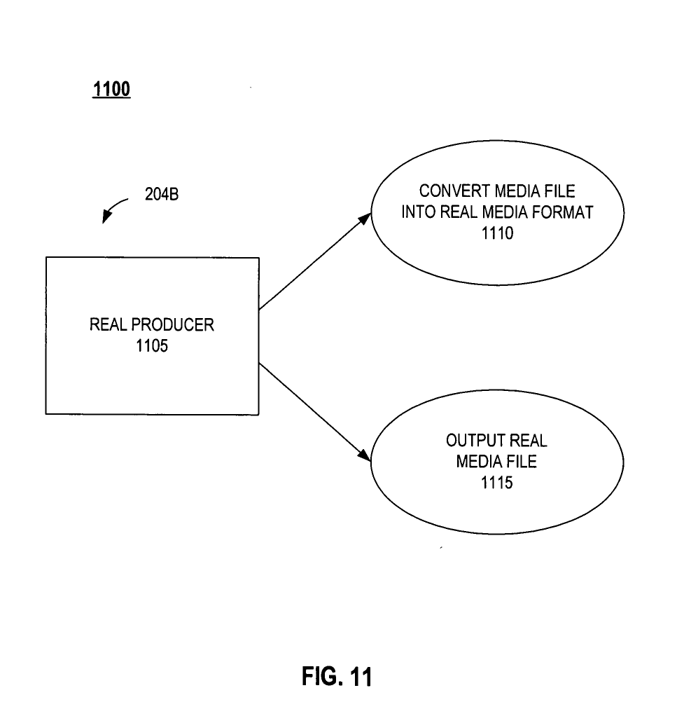

With regard to FIG. 11, the real producer 1105 such as, e.g., real producer 204B, may convert an input file to an output file in Real Media® format (.rm). The block 1110 illustrates an exemplary process of converting of a media file into real media format, which may include taking a file with, e.g., an avi format and may include converting the file into Real Media® format. Real Media is a registered trademark of RealNetworks, Inc. of Seattle, Wash., USA. At block 1115, the real producer 1105 may output a Real Media™ file. According to one exemplary embodiment of the present invention, the real producer 1105 may interact with the file that was produced by Task 1 (204a) in the key frame and audio service of FIG. 1, and may determine whether the file can be of .avi format, and then may convert the file to Real Media™ format. In alternative exemplary embodiments of the present invention, after producing a file, the real producer 1105 may also produce XML, which can be then inserted into the database 224 where the data can be stored.

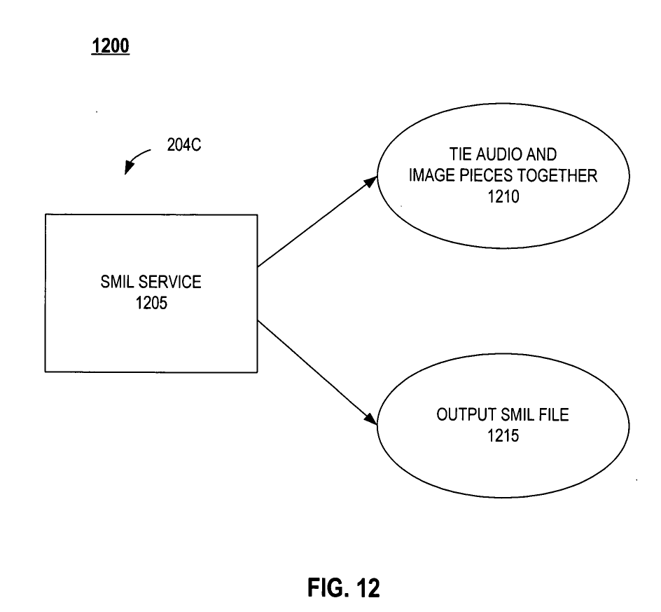

With regard to FIG. 12, a Synchronized Multimedia Integration Language (SMIL) service 1205, such as, e.g., but not limited to, SMIL service 204C, can be a mark-up language that may coordinate display of various media and/or multi-media. At block 1210, the SMIL service 1205 may provide for the integration of audio and image pieces into a single file that may be output as an SMIL file at block 1215. In one exemplary embodiment of the present invention, based on a listing of JPEG timestamps and audio timestamps, the SMIL service 1205 can match up a JPEG image to an audio track by synchronizing the audio with the changing key frames. In another exemplary embodiment of the present invention, this may be a post-process that may run after everything has been coded and logged.

In an alternative exemplary embodiment, an asset identifier and file to output the SMIL to may be given. In this exemplary embodiment, every component related to the asset identifier may be output in the SMIL format. In further exemplary embodiments, a SMIL file may be presentable on any one or a number of media players, such as, e.g., but not limited to, Real Player®, Windows® Media Player®.

In an alternative exemplary embodiment, the SMIL service 1205 may, at block 1210, tie the audio and image pieces together by pointing to the images and audio that Task 1 (204a) has produced and then may create a slideshow that may be based on their timestamps. The SMIL service may interact with the file that was produced by Task 1 by tying the audio and keyframe images together. After producing a SMIL file, the SMIL service 1205 may also produce XML, which can be then inserted into the database 224 where the data can be stored.

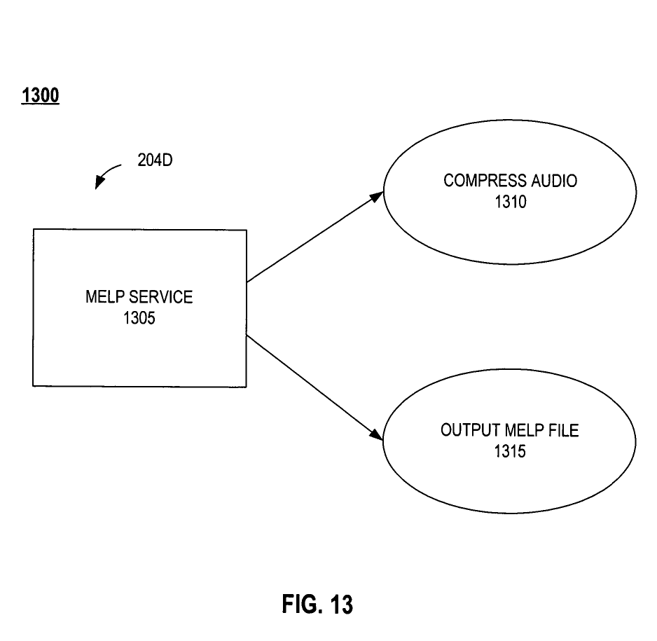

With regard to FIG. 13, in another exemplary embodiment, a Mixed Excitation Linear Predictive (MELP) service 1305, such as, e.g., but not limited to, MELP service 204D, may be utilized for, e.g., audio compression. At block 1310, the MELP service 1305 may compress audio produced by Task 1, creating a file, and at block 1315, outputting a MELP file. According to exemplary embodiments of the present invention, the MELP service1 305 may interact with the audio file that was produced by Task 1 (204a) by compressing it. According to alternative exemplary embodiments, after producing a MELP file, the MELP service 1305 may also produce XML, which can be then inserted into the database 224 where the data can be stored.

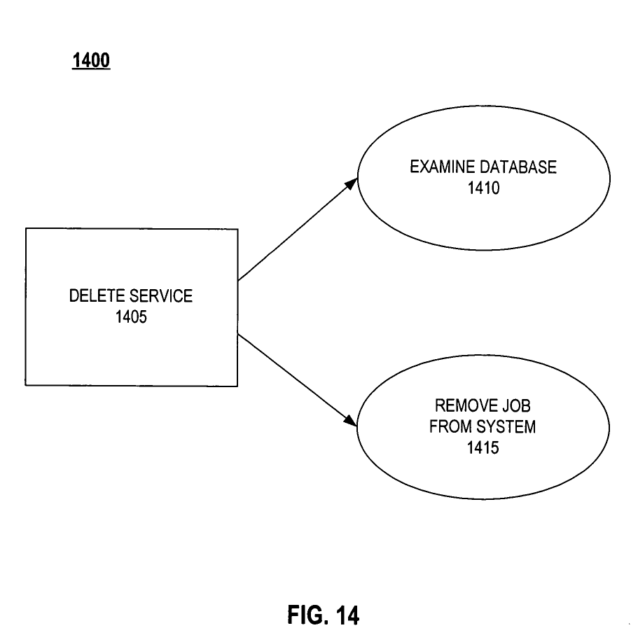

With regard to FIG. 14, a delete service 1405 may run in the background, and may be instantiated from a configured xml file. In one exemplary embodiment of the present invention, the delete service 1405 may examine the database 224 for jobs or processes that have started. In one exemplary embodiment of the present invention, the delete service 1405 may remove from the system a job or process. Furthermore, the delete service 1405 may operate in the background at all times, based on exemplary embodiments of the present invention. Additionally, user control over the delete service 1405 may be implemented via a script to start and/or stop the service 1405, as one skilled in the relevant arts would recognize based at least on the teachings provided herein.

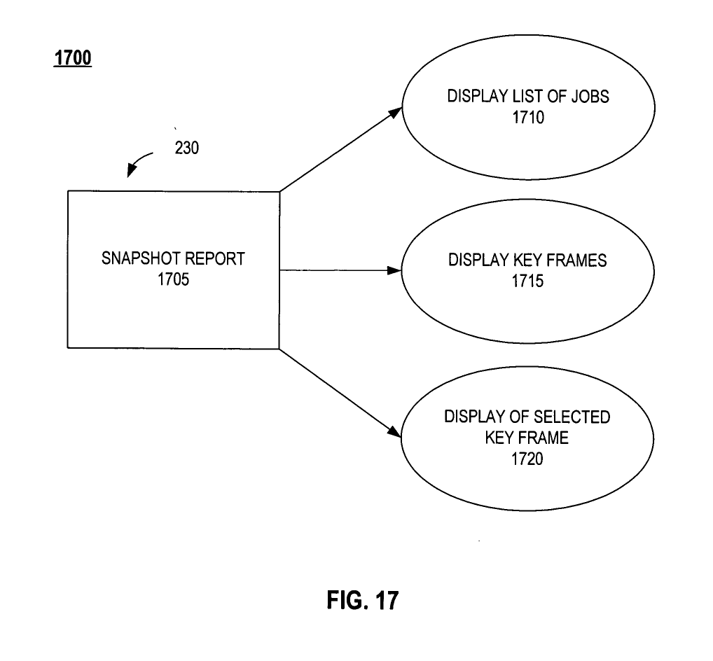

As shown in FIG. 14, the delete server 1405 may perform, in an exemplary embodiment, at least two functions which may include, e.g., but not limited to, as illustrated, functions that may examine database 1410 and may remove job from system 1415. Examine database 1410 may include scrutinizing each job in the database that is to be processed. If the job is to be removed, then the delete service may proceed to block 1415 and may remove the job from the system. Block 1415 may include deleting the job from the database if, after the examination, it finds that the job needs to be removed, thus removing related entries that are displayed in a snapshot report system. The delete service 1405 first interacts with the database 224 by determining if a job has started to be processed. In one exemplary embodiment of the present invention, the service can continue to monitor the database 224 to determine if a job needs to be removed if it has exceeded a specific configured processing time or if processing has finished after a specific period of time. In other exemplary embodiments, the delete service 1405 can also interact with a snapshot report tool (described in detail below with respect to FIG. 17), by trimming down the entries of the database that are displayed.

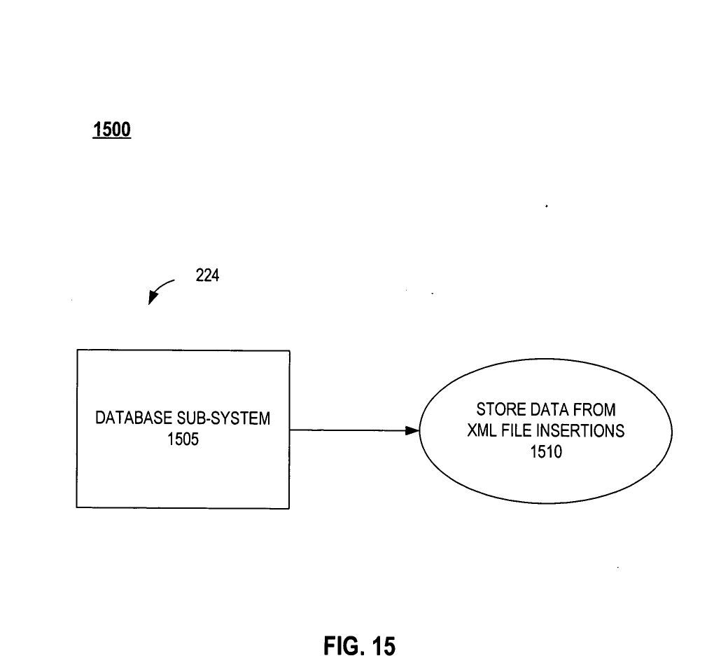

With regard to FIG. 15, a database subsystem (DS) 1505 such as, e.g., but not limited to, database 224, may encompass a back end subsystem for data storage and retrieval. The metadata extracted by the system of the present invention may be delivered to the DS 1505. The DS 1505 may then store the metadata in a multiply indexed fashion that may include information from all of the tasks 204a-d. Such indexing may allow for more inclusive retrieval of the metadata. The DS 1505 may include one or more databases and query databases, reporting tools, and other similar devices, as illustrated in FIG. 2. In exemplary embodiments of the present invention, each tool or device may provide a definition of the type of data (or metadata) that it will store, and a schema for how it will be stored. The DS 1505, thus, is designed to provide access to the data and to provide an asynchronous method by which on-going jobs may continue without stalling or complications at the processing end.

In one exemplary embodiment, the storing data block 1510 may include storing the XML file data from one or more of the audio service 1005, the histogram service 805, the real producer service 1105, the SMIL service 1205, and the MELP Service 1305 that was passed through each of the system's file sinks 222. The DS 1505 may interact with each of the systems and may contain the data that was produced by at least each of these services. In additional exemplary embodiments, the DS 1505 may also interact with the universal database viewer 228 by allowing its contents to be viewed by this tool.

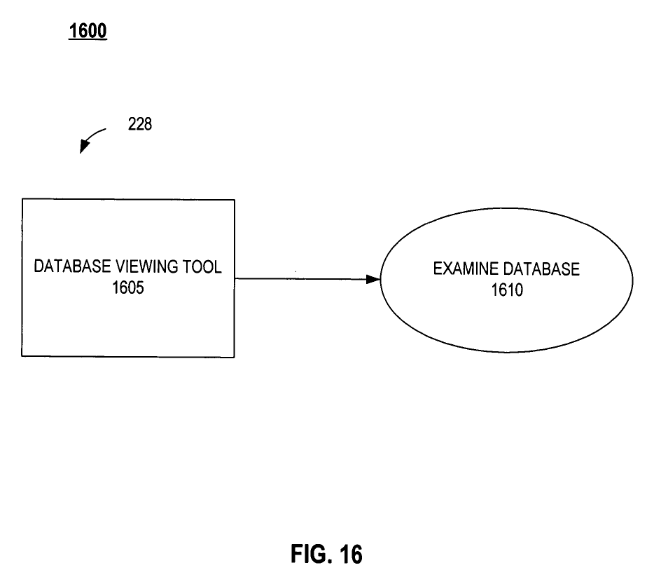

With regard to FIG. 16, a database viewing tool 1605, such as, e.g., but not limited to the universal database viewer 228, may enable database examination, as shown by block 1610. Block 1610 may include allowing users to view the contents of the databases at the time of running the tool 1605. The tool 1605 may interact with the databases, in which a developer can view its contents at any specific time.

With regard to FIG. 17, a snapshot report 1705 may run on one or more clients, or alternatively, anywhere there happens to be an instance of a browser running that can be part of the systems 100 or 200 over a network. The report 1705 may provide an interface whereby a user can see the progress of tasks that were previously submitted for processing by the directory watcher/scheduler process. According to exemplary embodiments of the present invention, the report 1705 may display a list of jobs sorted by date (block 1710). Additionally, a user can select a particular job and see a list of scene change snapshots for the job. Additionally when a user selects a particular snapshot, that snapshot can be displayed in the lower left quadrant in detail.

According to exemplary embodiments of the present invention, the snapshot report 1705 may display a list ofjobs at block 1710 to show all of the jobs that may have been processed or are being processed, along with the status of either being “active” or “done” in the processing stages. Additionally, the report 1705 may display key frames at block 1715, as well as displaying selected key frame at block 1720. In an alternative exemplary embodiment, the snapshot report 1705 may interact with the scheduler/directory watcher by reporting which jobs are currently being processed or are finished being processed. It also may interact with key frames, which may have been produced by Task 1 (204a), allowing the user to be able to view each of the key frames, in an indexing size or larger view.

### Additional and Alternative Exemplary Embodiments

The following alternative exemplary embodiments describe various methods for implementing the features described above and claimed below. These various alternative implementations of the present invention are presented by way of example, and not limitation. It will be apparent to persons skilled in the relevant art that various changes in form and detail may be made therein without departing from the spirit and scope of the invention.

According to one exemplary embodiment of the present invention, the systems 100 or 200 employ configuration files and attributes which include various interface classes. These configuration files, for example, are capable of setting the mimetype, base path, file root, table names, validation attributes, and other characteristics of, for instance, the audio services.

More specifically, in accordance to the exemplary embodiments, the mimetype refers to the type of audio that can be produced (for example, gsm, mpeg (mp3, mp2, mpa), wav, aiff (aiff, aif), au in Windows™ and gsm, mpeg (mp3, mp2, mpa), wav, aiff (aiff, aif), au in Linux); the basepath refers to where you want the result to go; the fileroot refers to what you want the audio to be called (alternatively, an asset id can be assigned as the filename); the table name refers to the table name in the database; and the validate attribute can reference the DTD validations which are rules for a set of XML to validate a XML schema.

The use of a configuration allows the audio service, such as, but not limited to audio services 204a and 1005, to produce any type of audio where a JMF multiplexer exists for that type of data. In the future, as a multiplexer is added and new formats are developed, the system will be able to handle them.

Another type of configuration file can be a database access file for the audio service, such as, but not limited to audio services 204a and 1005. According to one exemplary embodiment, after the audio service creates the XML file, it will save the output data results into the database with the table name of “AudioOutput”. If there is no AudioOutput table that exists, it will create one with that name (since “validate” has a value of “ON”). The xml file, which was created by the audio service, will then be copied after insertion into the database, into task 4 (MELP), as shown in the disposition code of the configuration file.

The delete service 1405, according to exemplary embodiments, is capable of reviewing assigned priorities, sleep timers, and the ability to remove jobs. More specifically, a job's priority refers to the priority in which the delete service 1405 runs in conjunction with other jobs. For example, a priority of “1” is the lowest priority level, which means that this job will run last. The maximum priority can be as high as a “10”, but is entirely configurable. A job's sleeptime refers to how long the delete service will sleep between scanning the database looking for items. A sleeptime of “30000” refers to 30000 milliseconds, (or 30 seconds). A toSeconds attribute refers to how old (in seconds) the job should exist in the database before the delete service deletes it. A toMinutes attribute refers to how old (in minutes) the job should exist in the database before the delete service deletes it. A toHours attribute refers to how old (in hours) the job should exist in the database before the delete service deletes it. A toMonths attribute refers to how old (in months) the job should exist in the database before the delete service deletes it. A httpMapConfig refers to the mapping between the logical and physical drive. A RemoveRunningJob refers to whether a job will get removed depending on if it is active or finished when the delete service is scanning for a timeout. If the value is set to “0”, the delete service will not remove the job if it is still active after the specified amount of time has passed. If the value is set to “1”, the delete service will remove that job from the database if it is still active after the specified amount of time has passed.

According to one alternative exemplary embodiment, delete service configuration settings can be removed. If this delete service configuration file is missing, all values will assume to their default values. In one exemplary embodiment, the default values can be stored in an AutomaticAssetDeleteConfig file, under a public class AutomaticAssetDeleteConfig.

According to exemplary embodiments, the histogram features 216a, 805 and 905 of the present invention are able to evaluate changes based on a threshold. An exemplary configuration file above can contain a threshold value.

The threshold value may be determined by a sensitivity factor. For example, a smaller value such as (0.1 or 0.15) may produce greater output due to being more sensitive. A larger number such as (0.3 or 0.4) may produce less output due to being less sensitive. Valid values for this parameter can be any number greater than zero or less than one.

The processing type may have an input value of HIST so that each frame is evaluated on a threshold. To use the Histogram to evaluate every Nth frame, the configuration file above will contain a threshold value. The threshold value will contain a specific number, such as 10, which will output every 10th frame. The processing type will contain any value that is not “HIST”. It can contain something like “>Nth”.

The exemplary embodiments of the directory watcher described above may perform by, but are not limited to, the following specific examples. Each directory watcher may load a configuration file. When the configuration file for the snapshots and audio task, the Task 1 (204a) directory will be watched and if a file with extensions of a particular type occurs, that file will be moved into an error folder, which will not be processed. If a file with other particular extensions occurs, that file will be mapped to be processed for Task 1 (204a).

With regard to the exemplary embodiments pertaining to the real producer task, the configuration file will be loaded by the Task 2 (204b) and if a file with an particular extension occurs, that file will be mapped to be processed for Task 2. All other files with different extensions will be mapped to an error folder, which will not be processed.

Similar example exist for the SMIL task and the MELP task, as one of ordinary skill in the art would recognized based at least on the teachings provided herein.

In exemplary embodiments similar to those described above, the scheduler, such as, but not limited to the schedulers 210a-d, may schedule tasks and services by use of a configuration file. The configuration file for the scheduler of task manager 212 may include information for the histogram and audio service 216a-b, as well as the snapshot reports 1705.

Additional exemplary embodiments include a scheduler for the real producer task, also known as the real producer service, which creates a real producer file and an xml file. The configuration file saves the information for the xml file sink, as illustrated in FIG. 2. In one exemplary embodiment, after the real producer creates the xml file, it will save the output data results into the database with the table name of “realproducer”. If there is no real producer table that exists, it will create one with that name. The xml file, which was created by real producer, will then be deleted after insertion into the database, as may be indicated by the disposition code of the configuration file for the real producer. In one example, an output file disposition for the real producer file created by real producer service could also be added later. This would allow the initial real producer file to be transferred, moved, copied, and/or deleted.

In an exemplary embodiment for the SMIL service, the scheduler may create a SMIL presentation file and an xml file. The configuration files storing the information for the xml file sink. In this example, after SMIL creates the xml file, it will save the output data results into the database with the table name of “smil”. If there is no SMIL table that exists, it will create one with that name. The xml file, which was created by SMIL, will then be deleted after insertion into the database, as shown in the disposition code of the configuration file. An output file disposition for the SMIL file created by the SMIL service could also be added later. This would allow the actual SMIL file to be transferred, moved, copied, and/or deleted.

In a similar exemplary embodiment of the present invention, with respect to the MELP service, the scheduler creates a MELP file and an xml file. The configuration files stores the information for the xml file sink. In one example, after MELP creates the xml file, it will save the output data results into the database with the table name of “melp”. If there is no MELP table that exists, it will create one with that name. The xml file, which was created by SMIL, will then be deleted after insertion into the database, as shown in the disposition code of the configuration file. An output file disposition for the MELP file created by the MELP service could also be added later. This would allow the actual MELP file to be transferred, moved, copied, and/or deleted.

As one of ordinary skill in the relevant arts would recognize, based at least on the teaching presented herein, the configuration files described above may include various attributes and variable settings within which values may be stored and read by the services so that they may perform their functions in accordance with the system as a whole, other components of the system, and/or the parameters specified by the user(s) of the system of the present invention.

As mentioned above, there are various plug-ins which may be utilized by the present invention, as illustrated in FIG. 1, element 112. In one exemplary embodiment of the present invention, the video capture plug-in includes a configuration for the task manager of Task 1. The configuration may make a copy of the content file for the directories of both Task 2 (real producer) and Task 3 (SMIL task/service) either before or after the key frame and audio service is complete, but in certain exemplary embodiments, it is preferred to copy the content file after the key frame and audio service is complete. Once Task 1 is finished with either the configuration file or the content file, they may be deleted or stored. In exemplary embodiments of the present invention, the configuration file may also specify the tracks and tools for the task manager in task 1. With respect to the video capture plugin, the configuration file may include information about the following: 1) a JMF adapter, which may only have output tracks, and may only send out streams; 2) a splitter, which may have an input track from the JMF Adapter and an output track with two tracks from the same type; and 3) a sink, which may only have input tracks.

Additional exemplary embodiments may employ plug-ins for key framing and the track sink of the key frame. Such plug-ins may utilize a source frame as a reference track and thus provide additional tracks for one or more key frames.

According to exemplary embodiments of the present invention, the reporting devices may include viewers for viewing snapshots of the databases, of both or either content or metadata. These devices may include configuration files which may be referenced for reporting preferences and capabilities. In one exemplary embodiment of the present invention, the configuration file may allow for a quick change to various report types, such as but not limited to assets, snapshots, and view, appear and behave differently.

In exemplary embodiments of the present invention, the above-described data sink, such as the YUV data sink, may be used with the histogram service, such as, but not limited to the histogram service 805. The data sink may, according to exemplary embodiments, use a configuration file that stores information about one or more buffers (data sinks) of the key frames from the histogram service.

### Computer Environment

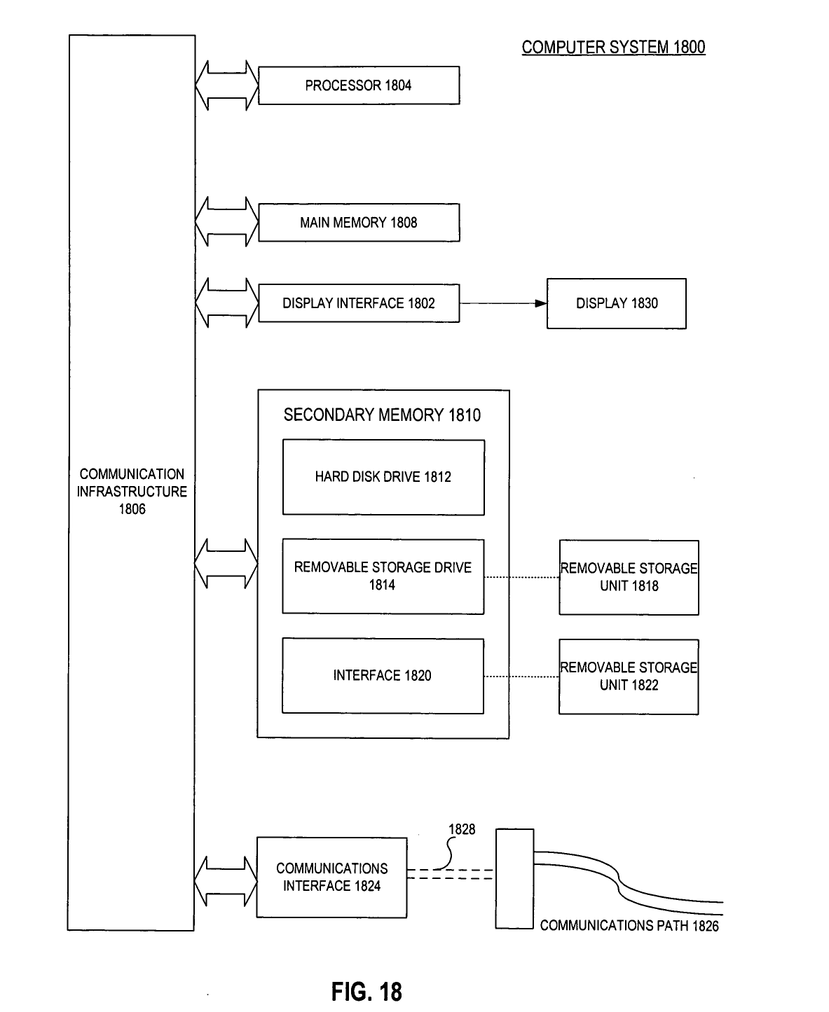

The present invention (i.e., the MediaMiner metadata extraction content processing system 100 and 200 or any part thereof) may be implemented using hardware, software or a combination thereof and may be implemented in one or more computer systems or other processing systems. In fact, in one exemplary embodiment, the invention can be directed toward one or more computer systems capable of carrying out the functionality described herein. An example of a computer system 1800 can be shown in FIG. 18. The computer system 1800 includes one or more processors, such as processor 1804. The processor 1804 can be connected to a communication infrastructure 1806 (e.g., a communications bus, cross over bar, or network). Various software exemplary embodiments are described in terms of this exemplary computer system. After reading this description, it can become apparent to a person skilled in the relevant art(s) how to implement the invention using other computer systems and/or computer architectures.

Computer system 1800 can include a display interface 1802 that forwards graphics, text, and other data from the communication infrastructure 1806 (or from a frame buffer not shown) for display on the display unit 1830.

Computer system 1800 also includes a main memory 1808, preferably random access memory (RAM), and may also include a secondary memory 1810. The secondary memory 1810 may include, for example, a hard disk drive 1812 and/or a removable storage drive 1814, representing a floppy disk drive, a magnetic tape drive, an optical disk drive, etc. The removable storage drive 1814 reads from and/or writes to a removable storage unit 1818 in a well known manner. Removable storage unit 1818, represents a floppy disk, magnetic tape, optical disk, etc. which is read by and written to by removable storage drive 1814. As can be appreciated, the removable storage unit 1818 includes a computer usable storage medium having stored therein computer software and/or data.

In alternative exemplary embodiments, secondary memory 1810 may include other similar means for allowing computer programs or other instructions to be loaded into computer system 1800. Such means may include, for example, a removable storage unit 1822 and an interface 1820. Examples of such may include a program cartridge and cartridge interface (such as that found in video game devices), a removable memory chip (such as an EPROM, or PROM) and associated socket, and other removable storage units 1822 and interfaces 1820 which allow software and data to be transferred from the removable storage unit 1822 to computer system 1800.

Computer system 1800 may also include a communications interface 1824. Communications interface 1824 allows software and data to be transferred between computer system 1800 and external devices. Examples of communications interface 1824 may include a modem, a network interface (such as an Ethernet card), a communications port, a PCMCIA slot and card, etc. Software and data transferred via communications interface 1824 are in the form of signals 1828 which may be electronic, electromagnetic, optical or other signals capable of being received by communications interface 1824. These signals 1828 are provided to communications interface 1824 via a communications path (i.e., channel) 1826. This channel 1826 carries signals 1828 and may be implemented using wire or cable, fiber optics, a phone line, a cellular phone link, an RF link and other communications channels.

In this document, the terms “computer program medium” and “computer usable medium” are used to generally refer to media such as removable storage drive 1814, a hard disk installed in hard disk drive 1812, and signals 1828. These computer program products are means for providing software to computer system 1800. The invention can be directed to such computer program products.

Computer programs (also called computer control logic) are stored in main memory 1808 and/or secondary memory 1810. Computer programs may also be received via communications interface 1824. Such computer programs, when executed, enable the computer system 1800 to perform the features of the present invention as discussed herein. In particular, the computer programs, when executed, enable the processor 1804 to perform the features of the present invention. Accordingly, such computer programs represent controllers of the computer system 1800.

In an exemplary embodiment where the invention can be implemented using software, the software may be stored in a computer program product and loaded into computer system 1800 using removable storage drive 1814, hard drive 1812 or communications interface 1824. The control logic (software), when executed by the processor 1804, causes the processor 1804 to perform the functions of the invention as described herein.

In another exemplary embodiment, the invention can be implemented primarily in hardware using, for example, hardware components such as application specific integrated circuits (ASICs). Implementation of the hardware state machine so as to perform the functions described herein will be apparent to persons skilled in the relevant art(s).

In yet another exemplary embodiment, the invention can be implemented using a combination of both hardware and software.

### CONCLUSION

While various exemplary embodiments of the invention have been described above, it should be understood that they have been presented by way of example, and not limitation. It will be apparent to persons skilled in the relevant art that various changes in form and detail may be made therein without departing from the spirit and scope of the invention. This is especially true in light of technology and terms within the relevant art(s) that may be later developed. Thus the invention should not be limited by any of the above described exemplary embodiments, but should be defined only in accordance with the following claims and their equivalents.

1. A machine accessible medium that provides instructions, which when executed by a computing platform, cause said computing platform to perform operations comprising a method comprising:
a) receiving content from one or more sources, wherein said content includes a corresponding given realtime running time length; and
b) extracting metadata from said content in a period of time that is less than said corresponding given realtime running time length.

2. The machine accessible medium according to claim 1, wherein said content comprises at least one of audio data, video data, still-frame data, and digital data.

3. The machine accessible medium according to claim 1, wherein said metadata comprises at least one of a snapshot, a stream, a program elementary stream (PES), a track, a time code, and a scene change.

4. The machine accessible medium according to claim 1, wherein said extracting comprises at least one of:
processing content corresponding to a given time period in substantially said given time period; and
processing content corresponding to a given time period in less than said given time period.

5. The machine accessible medium according to claim 1, wherein said extracting comprises:
processing content by at least one of: parallel processing and multi-tasking.

6. The machine accessible medium according to claim 1, wherein said (b) comprises at least one of:
1) extracting to optimize for throughput;
2) extracting to optimize for speed; and
3) extracting to optimize for quality.

7. The machine accessible medium according to claim 1, wherein said (b) comprises at least one of:
1) extracting a scene change;
2) extracting a face detection;
3) extracting a face recognition;
4) extracting an optical character recognition;
5) extracting a logo detection;
6) extracting text from audio;
7) extracting a key length value;
8) extracting geospatial data; and
9) extracting a closed captioning.

8. The machine accessible medium according to claim 1, wherein said (b) comprises:
1) extracting said metadata in a distributed manner.

9. The machine accessible medium according to claim 8, wherein said (b) (1) comprises at least one of:
i) extracting using one or more plugins;
ii) extracting using multiple streams on a server;
iii) extracting using multiple streams on more than one server;
iv) extracting using said one or more plugins on a server; and
v) extracting using said one or more plugins on more than one server.

10. The machine accessible medium according to claim 9, wherein said (b) (1) (i) comprises:
A) extracting using said one or more plug-ins, wherein said one or more plugins are of one or more configurations.

11. The machine accessible medium according to claim 1, wherein said (b) comprises:
1) extracting said metadata using deterministic analysis.

12. The machine accessible medium according to claim 11, wherein said (b) (1) comprises at least one of:
i) extracting said metadata to achieve repeatable results;
ii) extracting said metadata to analyze all frames;
iii) extracting said metadata to achieve no data loss; and
iv) extracting said metadata to achieve no lost frames.

13. The machine accessible medium according to claim 1, wherein said (b) comprises:
1) receiving external stream information; and
2) processing decisions based on said external stream information.

14. The machine accessible medium according to claim 13, wherein said external stream information includes at least one of size, resolution, encoding type, encoding parameters, frame rate, and data rate.

15. The machine accessible medium according to claim 1, wherein said content comprises compressed video and said (b) comprises at least one of:
1) identifying objects; and
2) identifying motion tracking of said objects.

16. The machine accessible medium according to claim 1, wherein said (b) comprises at least one of:
1) managing resources using load balancing;
2) managing resources using load balancing with a central registry; and
3) managing resources using fault tolerance methods.

17. The machine accessible medium according to claim 1, wherein said (b) comprises at least one of:
1) configuring a content processing engine;
2) reconfiguring said content processing engine; and
3) reconfiguring said content processing engine in real-time.

18. The machine accessible medium according to claim 1, wherein said method further comprises:
c) storing said metadata.

19. The machine accessible medium according to claim 1, wherein said method further comprises:
c) managing assets wherein said assets include at least one of said content and said metadata.

20. The machine accessible medium according to claim 19, wherein said (c) comprises at least one of:
1) receiving a search query;
2) displaying results of said search query; and
3) creating products from said results.

21. The machine accessible medium according to claim 20, wherein said (c) (1) comprises:
i) receiving a search query based on query terms.

22. The machine accessible medium according to claim 1, wherein said (b) is performed by a content processing engine, wherein said content processing engine is platform independent and written in an extensible object oriented programming language.

23. The machine accessible medium according to claim 1, wherein said (b) is performed by a global view content processing engine, and wherein (b) comprises at least one of:
1) correlating results of said data extractions intelligently from multiple input streams;
2) running multiple instances of said engine concurrently;
3) performing triggered event processing; and
4) maintaining a central registry listing availability and location of plugins.

24. The machine accessible medium according to claim 1, wherein said (b) is performed across an application programming interface using a scripted language wherein said scripted language comprises at least one of:
1) an extensible markup language;
2) an embedded language;
3) a command line based language; and
4) event handling via said scripting language.

25. The machine accessible medium according to claim 1, wherein said method further comprises:
c) displaying said metadata via an user interface.

26. The machine accessible medium according to claim 1, wherein said method further comprises:
c) clipping said content comprising at least one of:
1) segmenting said content;
2) marking a beginning and an ending of a plurality of key frames.

27. The machine accessible medium according to claim 1, wherein said content is at least one of intelligence industry content, law enforcement industry content, broadcast studio content, media asset management content, media and entertainment content, homeland defense content, distance learning content, security content, and business intelligence content.

28. A system to extract metadata comprising:
one or more tasks to receive at least one file of content, wherein said one or more tasks process said at least one file of content and extract metadata of one or more types;
one or more data sinks to filter said metadata based on said one or more types; and
a database to store said metadata, wherein said metadata is extracted in a period of time that is less than a running length of said content.

29. The system of claim 28, wherein said one or more tasks comprises at least one of:
an audio task to extract metadata about audio information from said content file;
a key frame task to extract metadata about one or more key frames in said content file;
a real producer task to extract metadata into real media format from said content file;
a synchronized multimedia integration language task to extract metadata from said content file; and
a mixed excitation linear predictive encoder task to extract metadata from said content file.

30. The system of claim 28, wherein said one or more components comprises at least one of:
a directory watcher to monitor one or more directories for said content file;
a scheduler to determine the processing operations or each of said one or more tasks; and
a task manager to line-up one or more plug-ins and allocate resources for said one or more tasks.

31. The system of claim 28, further comprising:
one or more database tools coupled to said database, wherein said one or more database tools view, produce and deliver reports, and query said database.

32. A method of processing metadata comprising:
a) receiving content from one or more sources; and
b) extracting metadata from said content faster than real-time.

33. The method according to claim 32, wherein said content comprises at least one of audio data, video data, still-frame data, and digital data.

34. The method according to claim 32, wherein said metadata comprises at least one of a snapshot, a stream, a program elementary stream (PES), a track, a time code, and a scene change.

35. The method according to claim 32, wherein said extracting in faster than real-time comprises:
processing content corresponding to a given time period in substantially said given time period.

36. The method according to claim 32, wherein said extracting in faster than real-time comprises:
processing content corresponding to a given time period in less than said given time period.

37. The method according to claim 32, wherein said step (b) comprises at least one of:
1) extracting to optimize for throughput;
2) extracting to optimize for speed; and
3) extracting to optimize for quality.

38. The method according to claim 32, wherein said step (b) comprises at least one of:
1) extracting a scene change;
2) extracting a face detection;
3) extracting a face recognition;
4) extracting an optical character recognition;
5) extracting a logo detection;
6) extracting text from audio;
7) extracting a key length value;
8) extracting geospatial data; and
9) extracting a closed captioning.

39. The method according to claim 32, wherein said step (b) comprises:
1) extracting said metadata in a distributed manner.

40. The method according to claim 39, wherein said step (b) (1) comprises at least one of:
i) extracting using one or more plugins;
ii) extracting using multiple streams on a server;
iii) extracting using multiple streams on more than one server;
iv) extracting using said one or more plugins on a server; and
v) extracting using said one or more plugins on more than one server.

41. The method according to claim 40, wherein said step (b) (1) (i) comprises:
A) extracting using said one or more plugins, wherein said one or more plugins are of one or more configurations.

42. The method according to claim 32, wherein said step (b) comprises:
1) extracting said metadata using deterministic analysis.

43. The method according to claim 43, wherein said step (b) (1) comprises at least one of:
i) extracting said metadata to achieve repeatable results;
ii) extracting said metadata to analyze all frames;
iii) extracting said metadata to achieve no data loss; and
iv) extracting said metadata to achieve no lost frames.

44. The method according to claim 32, wherein said step (b) comprises:
1) receiving external stream information; and
2) processing decisions based on said external stream information.

45. The method according to claim 44, wherein said external stream information includes at least one of size, resolution, encoding type, encoding parameters, frame rate, and data rate.

46. The method according to claim 32, wherein said content comprises compressed video and said step (b) comprises at least one of:
1) identifying objects; and
2) identifying motion tracking of said objects.

47. The method according to claim 32, wherein said step (b) comprises at least one of:
1) managing resources using load balancing;
2) managing resources using load balancing with a central registry; and
3) managing resources using fault tolerance methods.

48. The method according to claim 32, wherein said step (b) comprises at least one of:
1) configuring a content processing engine;
2) reconfiguring said content processing engine; and
3) reconfiguring said content processing engine in real-time.

49. The method according to claim 32, further comprising:
c) storing said metadata.

50. The method according to claim 32, further comprising:
c) managing assets wherein said assets include at least one of said content and said metadata.

51. The method according to claim 50, wherein said step (c) comprises at least one of:
1) receiving a search query;
2) displaying results of said search query; and
3) creating products from said results.

52. The method according to claim 51, wherein said (c) (1) comprises:
i) receiving a search query based on query terms.

53. The method according to claim 32, wherein said step (b) is performed by a content processing engine, wherein said content processing engine is platform independent and written in an extensible object oriented programming language.

54. The method according to claim 32, wherein said step (b) is performed by a global view content processing engine, and wherein step (b) comprises at least one of:
1) correlating results of said data extractions intelligently from multiple input streams;
2) running multiple instances of said engine concurrently;
3) performing triggered event processing; and
4) maintaining a central registry listing availability and location of plugins.

55. The method according to claim 32, wherein said step (b) is performed across an application programming interface using a scripted language wherein said scripted language comprises at least one of:
1) an extensible markup language;
2) an embedded language;
3) a command line based language; and
4) event handling via said scripting language.

56. The method according to claim 32, further comprising:
c) displaying said metadata via an user interface.

57. The method according to claim 32, further comprising:
c) clipping said content comprising at least one of:
1) segmenting said content;
2) marking a beginning and an ending of a plurality of key frames.

58. The method according to claim 32, wherein said content is at least one of intelligence industry content, law enforcement industry content, broadcast studio content, media asset management content, media and entertainment content, homeland defense content, distance learning content, security content, and business intelligence content.
